(19) United States
(12) Patent Application Publication
(10) Pub. No.: US 2012/0019471 A1
(43) Pub. Date: Jan. 26, 2012

(54) ENTERING INFORMATION INTO A COMMUNICATIONS DEVICE

(76) Inventor: Carsten Schlipf, Gaeufelden (DE)

(21) Appl. No.: 13/260,947

(22) PCT Filed: Apr. 20, 2009
(86) PCT No.: PCT/US09/37963

§ 371 Date: Sep. 29, 2011

(51) Int. Cl. G06F 3/041

(52) U.S. Cl. 345/173; 178/18.03

(57) ABSTRACT

A method for entering information into a communications device is disclosed. The method includes a user sliding a finger along a touch bar in either a horizontal or vertical direction to select a symbol. The method continues with the user selecting the symbol when the symbol enters the selection area, in which the appearance of the symbol is accentuated as the symbol enters the selection area.

### BACKGROUND

In many mobile communications devices, the keypad of the device serves the dual purpose of entering numbers, such as phone numbers and other numeric data, as well as for entering text data, such as information that may form the content of an SMS (short message service) message. This allows communications device to conveniently send and receive text messages while still retaining the capability to operate as a voice communications device.

However, when entering SMS text messages, the user must often apply multiple key presses in order for a particular character to be selected. For example, in order to enter the letter “S”, the user must depress the “7” key four times before the “S” can be selected. Additionally, in the event that the user delays for even a fraction of a second between subsequent key presses, the intended character may not be displayed. The user must then clear the incorrect entry and attempt to reenter the desired character. This can be frustrating to the user as well as requiring an inordinate amount of time to compose a simple SMS text message.

### BRIEF DESCRIPTION OF HE DRAWINGS

FIG. 1 shows a typical mobile telephone having a conventional user interface.

FIGS. 2-4 show a communications device having a user interface in accordance with an embodiment of the invention.

FIG. 5 shows a communications device having a user interface in accordance with another embodiment of the invention.

FIG. 6 shows a communications device having a user interface in accordance with another embodiment of the invention.

FIG. 7 shows a communications device having a user interface in accordance with another embodiment of the invention.

FIG. 8 shows a communications device having a user interface in accordance with another embodiment of the invention.

FIG. 9 is a block diagram of a logic module for use in a communications device according to an embodiment of the invention.

### DESCRIPTION OF THE EMBODIMENTS

FIG. 1 shows a typical mobile telephone having a conventional user interface. In FIG. 1, mobile telephone 10 includes display 20, alphanumeric keys 30, and function keys 40. The user of mobile telephone 10 may make wireless telephone calls using alphanumeric keys 30 to enter the recipient's telephone number. The user of mobile telephone 10 may also send SMS text messages by using alphanumeric keys 30, with the content of the text messages being displayed on display 20. Other functions of the mobile telephone may be executed using function keys 40. In conventional devices, function keys 40 may enable a camera function or may be used to perform various other functions, such as ring tone selection, preset number storage, selecting games, and numerous other functions.

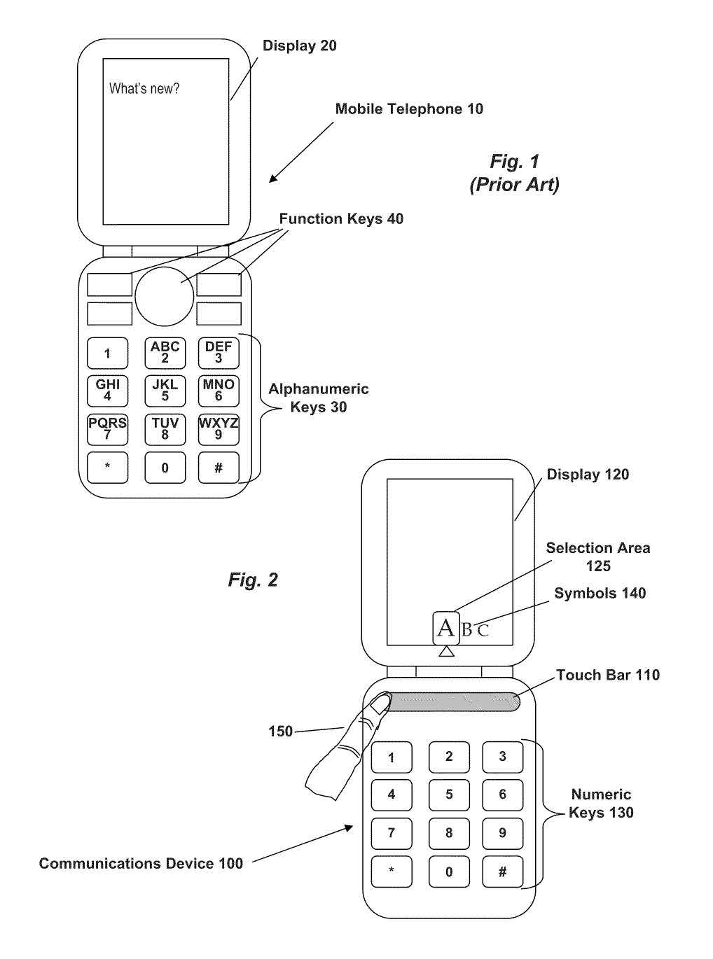

FIGS. 2-4 show a communications device having a user interface in accordance with an embodiment of the invention. In FIGS. 2-4, communications device 100 includes display 120, numeric keys 130, as well as touch bar 110. In the embodiments of FIGS. 2-4, it will be seen that numeric keys 130 are not required to be used to enter alphabetical characters. Additionally, the inclusion of touch bar 110 represents an efficient means of entering text into communications device 100 while consuming only minimal surface area. In accordance with the embodiments of FIGS. 2-4, entry of symbols, which may include alphabetical characters, is accomplished by way of the user manipulating touch bar 110 by way of his/her finger, 150. Further, the inclusion of touch bar 110 allows the communications device to be placed into a text-entry mode as soon as the user touches the touch bar, without requiring the user to manually place the communications device into a text entry mode.

In the embodiments herein, the communications device (such as communications device 100, 101, 102, and 200) may be one of several classes of devices. In some embodiments, the communications device may primarily perform wireless voice communications with SMS text message transmission and reception being a feature of the communications device. In other embodiments, the communications device may primarily perform handheld gaming or other entertainment functions and include a capability to transmit and receive text messages. In still other embodiments, the communications device may transmit and receive text messages that do not conform to an SMS protocol, but may instead conform to a non-SMS standard such as the GPRS (General Packet Radio Service) communications protocol.

In the embodiment of FIG. 2, when the user's finger 150 comes in contact with touch bar 110, symbols 140 are displayed at the lower portion of display 120. Near the center of the lower portion of display 120, selection area 125 presents the symbol to be selected by the user. When the user determines that the intended symbol is within selection area 125, the user may depress touch bar 110, or perhaps double click on the touch bar in order to select the intended symbol.

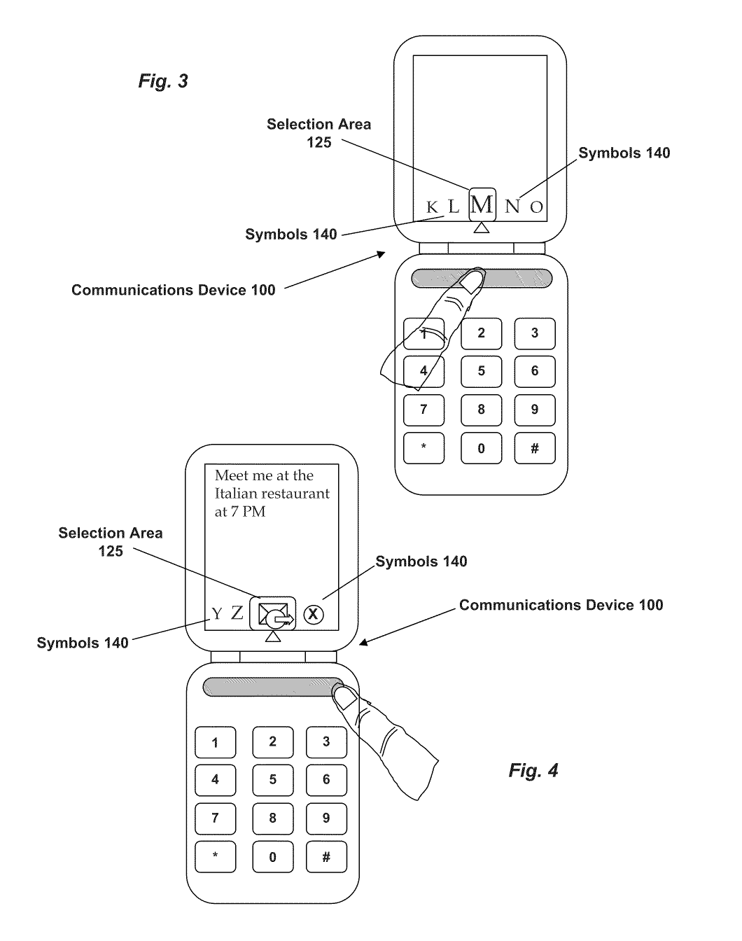

In the embodiments of FIG. 2-4, touch bar 110 operates much like a conventional touchpad used in a notebook or laptop computer operating in an “absolute positioning” mode along a single dimension. Two-dimensional operation of touch pad 110 is not contemplated in the embodiments described herein; however, nothing precludes the use of a two-dimensional touchpad in other embodiments of the invention. In the context of the embodiments described herein, the term “absolute positioning” implies that whenever the user applies his or her finger 150 to a left portion of touch bar 110, symbols near the beginning of a symbol library are displayed. Thus, when using a Western-style alphabet, when the user's finger 150 comes into contact with the left side of touch bar 110, symbols corresponding to alphabetical characters “A”, “B”, and “C” are displayed, with the character “A” being within selection area 125. In a similar manner, as shown in FIG. 3, when the user's finger 150 comes into contact with a middle portion of touch bar 110, symbols 140 displayed in the lower portion of display 120 may be symbols corresponding to characters from the middle of the alphabet, such as “L”, “M”, and “N”, with the character “M” being within the selection area. Further, as shown in FIG. 4, when user's finger 150 comes into contact with the right side of touch bar 110, symbols 140 displayed in the lower portion of display 120 may be characters from the end of the alphabet, such as “Y” and “Z”.

In FIGS. 2-4, it is contemplated that the locations along touch bar 110 correspond to an “ordered symbol library” stored in the memory of communications device 100 as explained in greater detail hereinafter. Further, the ordered symbol library used in the embodiments herein is not restricted to including only alphabetical characters. As can be seen in the embodiments of FIGS. 4, 7, and 9, the ordered symbol library may include one or more icons which allow the user to send a message as well as other icons that command communications device 100 to perform other functions. These functions may include deleting previously entered symbols, displaying a calendar, commanding the communications device to play audio or video files, commanding the device to enter a gaming mode, and so forth.

Although the embodiments of FIGS. 2-4 contemplate the operation of the touch bar in an absolute positioning mode, in which touching a particular location of touch bar 110 brings about the display of specific symbols (for example, when the user touches the left most portion of touch bar 110, the first characters of the alphabet are displayed), nothing prevents the use of relative positioning. In a relative positioning scheme, the user slides his or her finger in a horizontal direction along touch bar 110, As his or her finger slides along the length of the touch bar, a portion of the alphabet is scrolled within the lower portion of display 120.

Returning now to FIG. 2, near the center of the lower portion of display 120, selection area 125 displays to the user the symbol which may be selected should the user depress touch bar 110 (an operation similar to a computer mouse click). In other embodiments of the invention, the user may select the symbol within selection area 125 by double-clicking touch bar 110. As can also be seen in FIG. 2, when symbols 140 enter selection area 125, those symbols are accentuated. In FIG. 2, this accentuation is shown as the symbol being displayed larger than adjacent symbols. Symbols adjacent to the selection area, such as the character “B”, may also be accentuated, but not to the level of the character shown in selection area 125. Characters even further removed from the selection area, such as the character “C” of FIG. 2, may be displayed with less accentuation or none at all.

In FIG. 3, as the user slides his or her finger 150 in a horizontal direction from left to right across touch bar 110, the symbols of the alphabet move from right to left in the lower portion of display 120. Should the user's finger stop near the center of the touch bar, characters near the middle appear within or perhaps proximate to selection area 125 (as previously mentioned herein). In FIG. 3, should the user depress or double tap touch bar 110, the character “M” is selected. Should the user slide his/her finger slightly to the right, the character “N” may appear within selection area 125.

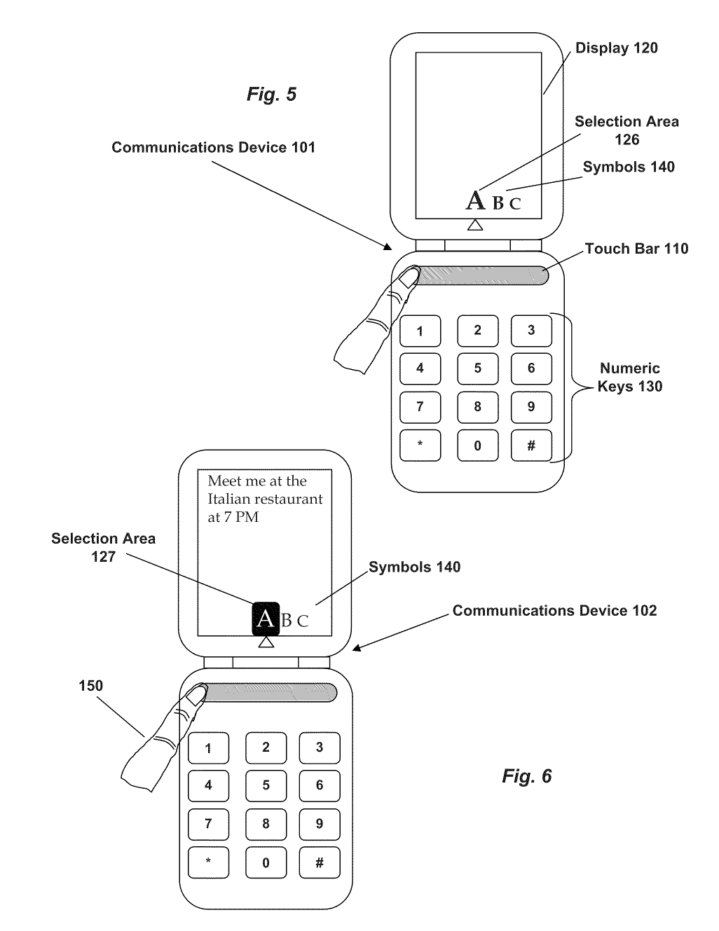

FIG. 5 shows a communications device having a user interface in accordance with another embodiment of the invention. The communications device (101) of FIG. 5 operates in a manner similar to that of communications device 100 of FIGS. 2-4. In the embodiment of FIG. 5, the symbol within selection area 126 (“A”) is accentuated using boldface type. Symbols adjacent to selection area 126, such as the character “B”, are accentuated using slightly less boldface type. Symbols further removed from the selection area, such as the character “C”, may be accentuated with little boldface type or perhaps not be accentuated at all.

FIG. 6 shows a communications device having a user interface in accordance with another embodiment of the invention. Communications device 102 of FIG. 6 operates in a manner similar to that of communications device 100 of FIGS. 2-4. In the embodiment of FIG. 6, the symbol within selection area 127 may be shown as a negative of the symbols outside of the selection area. The embodiment of FIG. 6 may be particularly useful when the user has a need to display the character within the selection area with maximum contrast.

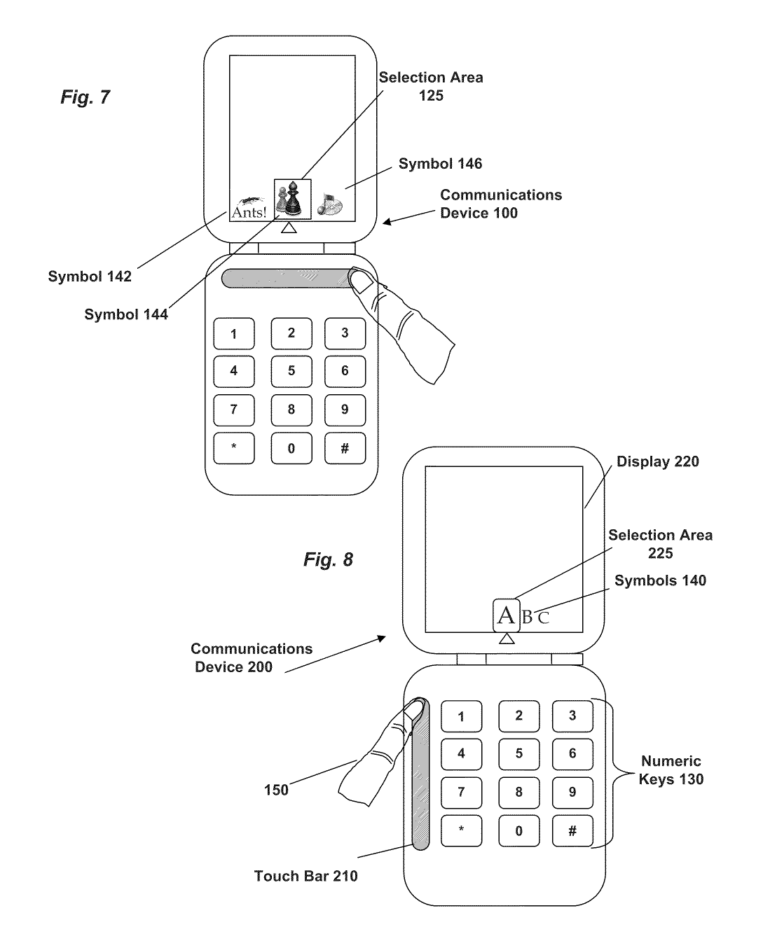

FIG. 7 shows a communications device having a user interface in accordance with another embodiment of the invention. In FIG. 7, communications device 100 is shown as having the capability to perform additional functions other than SMS text messaging and voice communications. In the example of FIG. 7, symbol 142 indicates that the user can watch a video clip of the movie “Ants!” by interfacing with touch bar 110 to place the symbol into selection area 125. Symbol 144 represents a game (for example, chess) placed within selection area 125. By scrolling touch bar 110 slightly to the right, the user may select the compact disc and musical note icon, which may correspond to one or more of the user's music files stored on communications device 100.

In other embodiments of the invention, touch bar 110 may allow the user to perform a more advanced control function of a videogame. Thus, for example, should the user select a “Racecar” game, touch bar 110 may be used as a control input to the game to “steer” the car along the course as the course is displayed on a display 120.

FIG. 8 shows a communications device having a user interface in accordance with another embodiment of the invention. In FIG. 8, touch bar 210 performs features similar to those of touch bar 110 of FIGS. 2-7. As can be seen from FIG. 8, the touch bar has been oriented along a vertical dimension of communications device 200. However, beyond this physical reorientation, it is contemplated that touch bar 210 operates in a manner very similar to that of touch bar 110. Since the touch bar has been oriented adjacent to numeric keys 130 (which function in a manner very similar to numeric keys 30 of FIGS. 2-7), display 220 can be made slightly wider than display 120. Thus, communications device 200 can be of a slightly different form factor than communications device 100 of FIGS. 2-4.

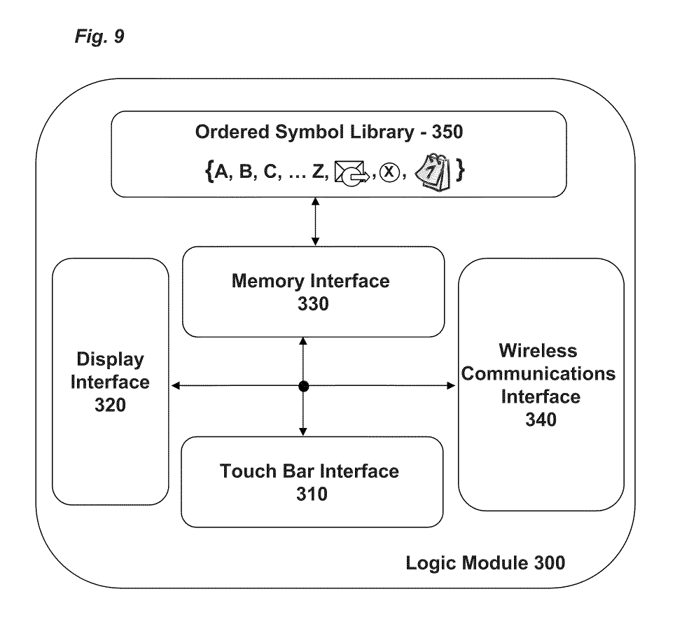

FIG. 9 is a block diagram of a logic module for use in a communications device according to an embodiment of the invention. In FIG. 9, logic module 300 includes various interfaces that control and direct the functionality of communications devices 100, 101, 102, or 200. Logic module 300 is contemplated as including touch bar interface 310, display interface 320, memory interface 330 (which access is ordered symbol library 350), and wireless communications interface 340. In the embodiment of FIG. 8, touch bar interface 310 receives data corresponding to the location of a user's finger when the user's finger is proximate with the touch bar. In this manner, when the user touches the touch bar, touch bar interface to 310 detects that the user has made contact with the touch bar and determines the location along the touch bar that such contact has been made.

When touch bar interface 310 detects that the user has made contact with the touch bar, the location of the user's finger is conveyed to memory interface 330. Memory interface 330 then retrieves from ordered symbol library 350 the symbol associated with the particular location along touch bar 110 corresponding to the location of the user's finger. The symbol information is then conveyed to display interface 320 which displays the symbol to the user within a selection area, such as selection area 125 of FIGS. 2-4. This symbol-by-symbol composition of the text message continues until the user has displayed an entire message on a display of the communications device. When the user has entered all desired symbols, the user may select to send the message by way of selecting the “send” icon from ordered symbol library 350. Subsequently, the message displayed is formatted and conveyed to wireless communications interface 340 for modulation and transmission to the designated recipient.

In conclusion, while the present invention has been particularly shown and described with reference to various embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

1. A method for entering information into a communications device, comprising:
a user sliding a finger along a touch bar in a direction selected from the group of horizontal and vertical to select a symbol; and
the user selecting the symbol when the symbol enters a selection area, wherein
the appearance of the symbol is accentuated as the symbol enters the selection area.

2. The method of claim 1, wherein the touch bar is oriented in a horizontal direction on the surface of the communications device.

3. The method of claim 1, wherein the touch bar is oriented in a vertical direction on the surface of the communications device.

4. The method of claims 1, wherein the symbol is an alphabetical character.

5. The method of claim 1, wherein the symbol is an icon that causes the communications device to perform a function.

6. The method of claim 1, wherein the symbol in the selection area is accentuated by appearing larger than at least one other symbol, the at least one other symbol being adjacent to the selection area.

7. The method of claim at 6, wherein the at least one other symbol being adjacent to the selection area is accentuated by appearing larger than at least one further symbol, the at least one further symbol not being present in the selection area and not being adjacent to the selection area.

8. The method of claim 1, wherein the symbol is made to appear bold when compared to at least one other symbol adjacent to the selection area.

9. The method of claim 1, wherein the symbol is made to appear as a negative image when compared to at least one other symbol adjacent to the selection area.

10. A communications device, comprising:
a touch bar for entering information into the communications device; and
a display for displaying symbols selected by way of the touch bar; wherein
the selected symbol is accentuated in a selection area, the selection area being a portion of the display.

11. The communications device of claim 10, wherein the touch bar is oriented in a horizontal direction on the surface of the communications device.

12. The communications device of claim 10, wherein when a user makes contact with the touch bar, the symbol displayed in the selection area corresponds to the absolute position of the symbol in an ordered symbol library stored in a memory of the communications device.

13. The communications device of claim 12, wherein when the user makes contact with a left portion of the touch bar, a character near the beginning of an alphabet appears in the selection area, and wherein when the user makes contact near the right portion of the touch bar, a character later in the alphabet appears in the selection area.

14. The communications device of claim 10, wherein the symbols displayed by the display correspond to at least one of the group consisting of audio files.

15. The communications device of claim 10, wherein the display is additionally capable of displaying images related to a game, and wherein the touch bar is used to provide a control input to the game.
